(19) United States
(12) Patent Application Publication
(10) Pub. No.: US 2025/0109334 A1
(43) Pub. Date: Apr. 3, 2025

(54) COMPOSITIONS THAT INCLUDE SAND AND A STABILIZING AGENT AND RELATED METHODS

(71) Applicants: Saudi Arabian Oil Company, Dhahran (SA); King Fahd University of Petroleum & Minerals, Dhahran (SA)

(72) Inventors: Emmanouil Spyropoulos, Dhahran (SA); Mohammed Al Mehthel, Dhahran (SA); Mohammed Maslehuddin, Dhahran (SA); Sami A. Al Abduljabbar, Dhahran (SA); Saleh A. Wohaibi, Dammam (SA); Mohammed Khaliluddin, Al Khobar (SA)

(21) Appl. No.: 18/479,464

(22) Filed: Oct. 2, 2023

(30) Foreign Application Priority Data
Sep. 28, 2023 (GR) 20230100780

(51) Int. Cl. C09K 17/44; E01C 7/14; E01C 7/30; E02B 7/08; E02D 17/20; E02D 27/00

(52) U.S. Cl. CPC C09K 17/44; E01C 7/142; E01C 7/30; E02B 7/08; E02D 17/20; E02D 27/00; E02D 2300/0018; E02D 2300/0079

(57) ABSTRACT

The disclosure relates to compositions that include sand mixed with a stabilizing agent that includes i) hydrocarbon derivative fibers and cement, ii) acrylic-based polymer emulsions, or iii) hydrocarbon derivative fibers and acrylic-based polymer emulsions, as well as related methods.

### FIELD

The disclosure relates to compositions that include sand mixed with a stabilizing agent that includes i) hydrocarbon derivative fibers and cement, ii) acrylic-based polymer emulsions, or iii) hydrocarbon derivative fibers and acrylic-based polymer emulsions, as well as related methods.

### BACKGROUND

Soils are commonly used in embankments, highways, and water retaining structures. Sand is a commonly available soil, but due to its loose and cohesionless structure, is prone to liquefaction, collapse and sliding.

### SUMMARY

The disclosure relates to compositions that include sand mixed with a stabilizing agent that includes i) hydrocarbon derivative fibers and cement, ii) acrylic-based polymer emulsions, or iii) hydrocarbon derivative fibers and acrylic-based polymer emulsions, as well as related methods.

The compositions and methods can stabilize sand, allowing for its use in infrastructure projects, e.g., in situations where sand would otherwise not be appropriate for use. The compositions can exhibit relatively good properties (e.g., relatively high compressive strength, tensile strength and/or bearing capacities) with relatively small amounts of additives (hydrocarbon derivative fibers, cement and/or acrylic-based polymer emulsions), relative to certain other compositions including sand and a stabilizing agent. For example, the compositions can provide improved performance relative to compositions that only include cement as a stabilizing agent.

In some embodiments, the compositions can reduce the amount of cement used, thereby reducing the generation of carbon dioxide and water consumption associated with the use of cement. In addition to using a reduced amount of stabilizing agents relative to certain other compositions, the components of the compositions can be relatively inexpensive. The compositions can therefore provide economic and environmental benefits relative to certain other known compositions used to stabilize sand.

In a first aspect, the disclosure provides a composition that includes: sand; 0.1% to 2% hydrocarbon derivative fibers by mass of the sand; and 0.1% to 3% cement by mass of the sand.

In some embodiments, the composition includes at least 95% by weight sand.

In some embodiments, the composition includes 0.2% to 1% hydrocarbon derivative fibers by mass of the sand, and 2% cement by mass of the sand.

In some embodiments, the hydrocarbon derivative fibers include polypropylene fibers, polyethylene fibers, polyvinyl alcohol fibers, and/or polyvinyl acetate fibers.

In some embodiments, the composition includes 0.5% hydrocarbon derivative fibers by mass of the sand, and 2% cement by mass of the sand, and the hydrocarbon derivative fibers include polyvinyl acetate fibers.

In some embodiments, the composition has an unconfined compressive strength of at least 600 kPa according to ASTM D2166.

In some embodiments, the composition consists of sand, 0.1% to 2% hydrocarbon derivative fibers by mass of the sand, and 0.1% to 3% cement by mass of the sand.

In a second aspect, the disclosure provides a system, including a structure and a composition. The structure is selected from a road bed, a foundation, an embankment, a highway, a dam, flexible pavement, rigid pavement, a water retaining structure, an erosion protection and mitigation structure, a pipe sleeper, a fence foundation, a small pump, a masonry wall foundation, and/or a slab on grade foundation. The composition includes: sand; 0.1% to 2% hydrocarbon derivative fibers by mass of the sand; and 0.1% to 3% cement by mass of the sand. The composition supports at least a portion of the structure.

In a third aspect, the disclosure provides a composition that includes sand, and 0.1% to 5% acrylic-based polymer emulsion by mass of the sand.

In some embodiments, the composition includes at least 95% by weight sand.

In some embodiments, the composition has an unconfined compressive strength of at least 500 kPa according to ASTM D2166.

In some embodiments, the composition consists of sand, and 0.1% to 5% acrylic-based polymer emulsion by mass of the sand.

In a fourth aspect, the disclosure provides a system, including a structure and a composition. The structure is selected from a road bed, a foundation, an embankment, a highway, a dam, flexible pavement, rigid pavement, a water retaining structure, an erosion protection and mitigation structure, a pipe sleeper, a fence foundation, a small pump, a masonry wall foundation, and/or a slab on grade foundation. The composition includes sand and 0.1% to 5% acrylic-based polymer emulsion by mass of the sand. The composition supports at least a portion of the structure.

In a fifth aspect, the disclosure provides a composition that includes: sand; 0.1% to 2% hydrocarbon derivative fibers by mass of the sand; and 0.1% to 5% acrylic-based polymer emulsion by mass of the sand.

In some embodiment, the composition includes at least 95% by weight sand.

In some embodiments, the composition includes 0.2% hydrocarbon derivative fibers by mass of the sand, and 0.5% cement by mass of the sand.

In some embodiments, the hydrocarbon derivative fibers include polyvinyl acetate fibers, polypropylene fibers, polyethylene fibers, polyvinyl alcohol fibers, and/or polyvinyl acetate fibers.

In some embodiments, the composition has an unconfined compressive strength of at least 1900 kPa.

In some embodiments, the composition consists of sand, 0.1% to 2% hydrocarbon derivative fibers by mass of the sand, and 0.1% to 5% acrylic-based polymer emulsion by mass of the sand.

In a sixth aspect, the disclosure provides a system, including a structure and a composition. The structure is selected from a road bed, a foundation, an embankment, a highway, a dam, flexible pavement, rigid pavement, a water retaining structure, an erosion protection and mitigation structure, a pipe sleeper, a fence foundation, a small pump, a masonry wall foundation, and/or a slab on grade foundation. The composition includes: sand; 0.1% to 2% hydrocarbon derivative fibers by mass of the sand; and 0.1% to 5% acrylic-based polymer emulsion by mass of the sand. The composition supports at least a portion of the structure.

### BRIEF DESCRIPTION OF THE FIGURES

FIG. 1 depicts a bar graph of unconfined compressive strength (UCS) values of several compositions.

### DETAILED DESCRIPTION

### Compositions

In general, the compositions include sand and a stabilizing agent. In some embodiments, the stabilizing agent includes hydrocarbon derivative fibers and cement, and the composition includes sand, the hydrocarbon derivative fibers, and cement. In some embodiments, the stabilizing agent includes acrylic-based polymer emulsions, and the composition includes sand and the acrylic-based polymer emulsions. In some embodiments, the stabilizing agent includes hydrocarbon derivative fibers and acrylic-based polymer emulsions, and the composition includes sand, the hydrocarbon derivative fibers, and the acrylic-based polymer emulsions.

In certain embodiments, the compositions consist of sand and the stabilizing agent. In certain embodiments, the compositions consist of sand, hydrocarbon derivative fibers, and cement. In certain embodiments, the compositions consist of sand and acrylic-based polymer emulsions. In certain embodiments, the compositions consist of sand, hydrocarbon derivative fibers, and acrylic-based polymer emulsions.

Without wishing to be bound by theory, it is believed that the hydrocarbon derivative fibers, cement, and/or the acrylic-based polymer emulsions can improve the compressive strength, the tensile strength and/or the bearing capacity of the sand. Without wishing to be bound by theory, it is believed that the acrylic-based polymer emulsions can act as cementitious agents, which is believed to improve the cohesion and strength of the compositions. Without wishing to be bound by theory, it is believed that the cement provides cohesion properties for the sand and increases its compressive strength.

In general, any type of sand can be used in the compositions, such as, for example, dune sand, silica sand, valley sand, dredged sand. In some embodiments, a combination of different types of sand can be used.

In some embodiments, the compositions include at least 0.1 (e.g., at least 0.2, at least 0.3, at least 0.4, at least 0.5, at least 0.6, at least 0.7, at least 0.8, at least 0.9, at least 1, at least 1.1, at least 1.2, at least 1.3, at least 1.4, at least 1.5, at least 1.6, at least 1.7, at least 1.8, at least 1.9) % hydrocarbon derivative fibers by mass of the sand and/or at most 2 (e.g., at most 1.9, at most 1.8, at most 1.7, at most 1.6, at most 1.5, at most 1.4, at most 1.3, at most 1.2, at most 1.1, at most 1, at most 0.9, at most 0.8, at most 0.7, at most 0.6, at most 0.5, at most 0.4, at most 0.3, at most 0.2) % hydrocarbon derivative fibers by mass of the sand and at least 0.1 (e.g., at least 0.2, at least 0.3, at least 0.4, at least 0.5, at least 0.6, at least 0.7, at least 0.8, at least 0.9, at least 1, at least 1.1, at least 1.2, at least 1.3, at least 1.4, at least 1.5, at least 1.6, at least 1.7, at least 1.8, at least 1.9, at least 2, at least 2.1, at least 2.2, at least 2.3, at least 2.4, at least 2.5, at least 2.6, at least 2.7, at least 2.8, at least 2.9) % cement by mass of the sand and/or at most 3 (e.g., at most 2.9, at most 2.8, at most 2.7, at most 2.6, at most 2.5, at most 2.4, at most 2.3, at most 2.2, at most 2.1, at most 2, at most 1.9, at most 1.8, at most 1.7, at most 1.6, at most 1.5, at most 1.4, at most 1.3, at most 1.2, at most 1.1, at most 1, at most 0.9, at most 0.8, at most 0.7, at most 0.6, at most 0.5, at most 0.4, at most 0.3, at most 0.2) % cement by mass of the sand.

In some embodiments, the compositions include at least 0.1 (e.g., at least 0.2, at least 0.3, at least 0.4, at least 0.5, at least 0.6, at least 0.7, at least 0.8, at least 0.9, at least 1, at least 1.1, at least 1.2, at least 1.3, at least 1.4, at least 1.5, at least 1.6, at least 1.7, at least 1.8, at least 1.9, at least 2, at least 2.1, at least 2.2, at least 2.3, at least 2.4, at least 2.5, at least 2.6, at least 2.7, at least 2.8, at least 2.9, at least 3, at least 3.5, at least 4, at least 4.5) % acrylic-based polymer emulsion by mass of the sand and/or at most 5 (e.g., at most 4.5, at most 4, at most 3.5, at most 3, at most 2.9, at most 2.8, at most 2.7, at most 2.6, at most 2.5, at most 2.4, at most 2.3, at most 2.2, at most 2.1, at most 2, at most 1.9, at most 1.8, at most 1.7, at most 1.6, at most 1.5, at most 1.4, at most 1.3, at most 1.2, at most 1.1, at most 1, at most 0.9, at most 0.8, at most 0.7, at most 0.6, at most 0.5, at most 0.4, at most 0.3, at most 0.2) % acrylic-based polymer emulsion by mass of the sand.

In some embodiments, the compositions include at least 0.1 (e.g., at least 0.2, at least 0.3, at least 0.4, at least 0.5, at least 0.6, at least 0.7, at least 0.8, at least 0.9, at least 1, at least 1.1, at least 1.2, at least 1.3, at least 1.4, at least 1.5, at least 1.6, at least 1.7, at least 1.8, at least 1.9) % hydrocarbon derivative fibers by mass of the sand and/or at most 2 (e.g., at most 1.9, at most 1.8, at most 1.7, at most 1.6, at most 1.5, at most 1.4, at most 1.3, at most 1.2, at most 1.1, at most 1, at most 0.9, at most 0.8, at most 0.7, at most 0.6, at most 0.5, at most 0.4, at most 0.3, at most 0.2) % hydrocarbon derivative fibers by mass of the sand and at least 0.1 (e.g., at least 0.2, at least 0.3, at least 0.4, at least 0.5, at least 0.6, at least 0.7, at least 0.8, at least 0.9, at least 1, at least 1.1, at least 1.2, at least 1.3, at least 1.4, at least 1.5, at least 1.6, at least 1.7, at least 1.8, at least 1.9, at least 2, at least 2.1, at least 2.2, at least 2.3, at least 2.4, at least 2.5, at least 2.6, at least 2.7, at least 2.8, at least 2.9, at least 3, at least 3.5, at least 4, at least 4.5) % acrylic-based polymer emulsion by mass of the sand and/or at most 5 (e.g., at most 4.5, at most 4, at most 3.5, at most 3, at most 2.9, at most 2.8, at most 2.7, at most 2.6, at most 2.5, at most 2.4, at most 2.3, at most 2.2, at most 2.1, at most 2, at most 1.9, at most 1.8, at most 1.7, at most 1.6, at most 1.5, at most 1.4, at most 1.3, at most 1.2, at most 1.1, at most 1, at most 0.9, at most 0.8, at most 0.7, at most 0.6, at most 0.5, at most 0.4, at most 0.3, at most 0.2) % acrylic-based polymer emulsion by mass of the sand.

In some embodiments, the compositions include at least 95 (e.g., at least 95.5, at least 96, at least 96.5, at least 97, at least 97.5, at least 98, at least 98.5, at least 99, at least 99.5) % by mass sand and/or at most 99.8 (e.g., at most 99.5, at most 99, at most 98.5, at most 98, at most 97.5, at most 97, at most 96.5, at most 96, at most 95.5) % by mass sand.

In certain embodiments, the composition includes (or consists of) sand, hydrocarbon derivative fibers, and cement and the composition has an unconfined compressive strength (UCS) according to ASTM D2166 of at least 600 (e.g., at least 650, at least 700, at least 750, at least 800, at least 850, at least 900, at least 950, at least 1000, at least 1050, at least 1100, at least 1150, at least 1200, at least 1250, at least 1300, at least 1350, at least 1400, at least 1450, at least 1500, at least 1550) kiloPascals (kPa) and/or at most 1600 (e.g., at most 1550, at most 1500, at most 1450, at most 1400, at most 1350, at most 1300, at most 1250, at most 1200, at most 1150, at most 1100, at most 1050, at most 1000, at most 950, at most 900, at most 850, at most 800, at most 750, at most 700, at most 650) kPa.

In certain embodiments, the composition includes (or consists of) sand and acrylic-based polymer emulsions and the composition has an UCS according to ASTM D2166 of at least 500 (e.g., at least 550, at least 600, at least 650, at least 700, at least 750, at least 800, at least 850, at least 900, at least 950, at least 1000, at least 1050, at least 1100, at least 1150, at least 1200, at least 1250) kPa and/or 1300 (e.g., at most 1250, at most 1200, at most 1150, at most 1100, at most 1050, at most 1000, at most 950, at most 900, at most 850, at most 800, at most 750, at most 700, at most 650, at most 600, at most 550) kPa.

In certain embodiments, the composition includes (or consists of) sand, hydrocarbon derivative fibers, and acrylic-based polymer emulsions and the composition has an UCS of at least 1250 (e.g., at least 1300, at least 1350, at least 1400, at least 1450, at least 1500, at least 1550, at least 1600, at least 1650, at least 1700, at least 1750, at least 1800, at least 1850, at least 1900, at least 1950, at least 2000, at least 2050, at least 2100, at least 2150) kPa and/or at most 2200 (e.g., at most 2150, at most 2100, at most 2050, at most 2000, at most 1950, at most 1900, at most 1850, at most 1800, at most 1750, at most 1700, at most 1650, at most 1600, at most 1550, at most 1500, at most 1450, at most 1400, at most 1350) kPa.

Examples of the hydrocarbon derivative fibers include polypropylene fibers, polyethylene fibers, polyvinyl alcohol fibers, and polyvinyl acetate fibers.

In certain embodiments, the hydrocarbon derived fibers have a length of at least 6 (e.g., at least 8, at least 10, at least 12, at least 14, at least 16, at least 18, at least 20, at least 25, at least 30, at least 35, at least 40, at least 45) mm and/or at most 50 (e.g., at most 45, at most 40, at most 35, at most 30, at most 25, at most 20, at most 18, most 16, at most 14, at most 12, at most 10, at most 8) mm. In certain embodiments, the hydrocarbon derived fibers have a diameter of at least 30 (e.g., at least 35) mm and/or at most 40 (e.g., at most 35) mm. In certain embodiments, the hydrocarbon derived fibers have a diameter of 0.04 mm.

In some embodiments, the hydrocarbon derived fibers have a tensile strength of at least 450 (e.g., at least 500, at least 550, at least 600, at least 650, at least 700, at least 750, at least 800, at least 850, at least 900, at least 950, at least 1000, at least 1050, at least 1100, at least 1150, at least 1200, at least 1250, at least 1300, at least 1350, at least 1400, at least 1450, at least 1500, at least 1550) megaPascals (MPa) and/or at most 1600 (e.g., at most 1550, at most 1500, at most 1450, at most 1400, at most 1350, at most 1300, at most 1250, at most 1200, at most 1150, at most 1100, at most 1050, at most 1000, at most 950, at most 900, at most 850, at most 800, at most 750, at most 700, at most 650, at most 600, at most 550, at most 500) MPa. Without wishing to be bound by theory, it is believed that having a relatively high length to diameter ratio provides a relatively high tensile strength and modulus.

In general, any type of cement can be used in the compositions, such as, for example, ordinary Portland cement (OPC), sulfate resistant cement, and supplementary cementitious materials.

In general, the acrylic-based polymer emulsion can be any acrylic-based polymer that dissolves in water. In some embodiments, the acrylic-based polymer emulsion includes sodium polyacrylate, polymethylmethacrylate (PMMA) and/or polyacrylamide.

In certain embodiments, the acrylic-based polymer emulsion has a Brookfield viscosity (spindle 3, 20 rpm) as measured by ASTM D789 or D4878 of at least 10 (e.g., at least 15, at least 20, at least 25) poise and/or at most 30 (e.g., at most 25, at most 20, at most 15) poise. In certain embodiments, the acrylic-based polymer emulsion has a density of at least 1.03 (e.g., at least 1.04, at least 1.05, at least 1.06) grams per cubic centimeter (g/cm³) and/or at most 1.07 (e.g., at least 1.06, at least 1.05, at least 1.04) g/cm³. In certain embodiments, the acrylic-based polymer emulsion has a solid content of at least 58 (e.g., at least 59, at least 60, at least 61) % and/or at most 62 (e.g., at most 61, at most 60, at most 59) %.

In certain embodiments, the compositions can include natural materials, industrial byproducts, and/or recycled materials used as a filler or partial replacement of the cement. Examples of such materials include recycled plastic, steel dust, volcanic ash, silica fume, blast furnace slag, fly ash, oil ash, red muds, bag house dust, slag, gypsum or kiln dust and construction demolition waste.

### Methods

In general, the hydrocarbon derivative fibers are mixed with sand, then a second mix is performed with either the acrylic-based polymer emulsion or dry cement and water. Such a sequence can allow the sand and hydrocarbon derivative fibers to mix, then the agent to provide the cohesive properties (e.g., acrylic-based polymer, cement) is added. Without wishing to be bound by theory, it is believed that, in at least some cases, other sequences of mixing would not result in the fibers being part of the matrix. In general, additional water does not need to be added in embodiments that include the acrylic-based polymer emulsion because the emulsions already include water. In embodiments that include only sand and the acrylic-based polymer, the first mixing step can usually be omitted. In general, proper mixing of the components prior to dispersion on the sand to be stabilized is desirable to provide a relatively uniform distribution of the stabilizing agents in the sand.

In some embodiments, the stabilizers can be mixed with sand then added where desired. In some embodiments, the stabilizer be added directly to the sand in the ground and mixed.

In general, the mixture can include the same amount of the hydrocarbon derived fibers, cement, and/or acrylic-based polymer emulsions as the resulting composition. In certain embodiments, in compositions that include cement, the mixture includes at least 4 (e.g., at least 5, at least 6) % water by mass of sand and/or at most 7 (e.g., at most 6, at most 5) % water by mass of sand.

### Applications

In general, the compositions can be used in any application in which soil with relatively good physical and mechanical properties (e.g., UCS and California bearing ratio (CBR), bearing capacities) are desired. The compositions can be used to support at least a portion of a structure. The structure can be a road bed, a foundation, an embankment, a highway, a dam, flexible or rigid pavement, a water retaining structure, an erosion protection and mitigation structure, a pipe sleeper, a fence foundation, a small pump, a masonry wall foundation, and/or a slab on grade foundation. The structures can be constructed atop the compositions.

### Example

### Materials

Properties of the polypropylene fibers (PP) (Don Construction Products (DCP); DCP Saudi Co; Product Name: PP Fiber; Part Number: C02/01/11/155)
   Composition: Virgin polypropylene
   Form: High performance monofilament fiber
   Color: White
   Specific gravity (at 25° C.): 0.91
   Water solubility: insoluble at room temperature
   Tensile strength: 450-560 MPa
   Elastic modulus: 5100-6000 MPa
   Softening point: 150° C.
   Melting point: 165° C.
   Ignition point: 580° C.
   Diameter: 35±5 m
The polypropylene fiber complies with ASTM C-1116-1997, Type 3.
Properties of polyvinyl acetate fibers (PVAc) (NYCON-PVA from Nycon Corporation; SDS Number-2010; RECS15)
   Fiber Type: REC15
   Diameter (mm): 0.04
   Fiber length (mm): 8
   Tensile strength (N/mm²): 1600
   Elongation (%): 7
   Young's modulus (kN/mm²): 40
   Density: 1.3
Parameters were determined using ASTM C-1116, Section 4.1.3 and AC-32.
Properties of acrylic-based polymer emulsion (Don Construction Products (DCP); DCP Saudi Co; Product Name: Setsoil DC; Part Number: C03/02/03/013)
   Color: White, colorless when cured
   Brookfield viscosity (spindle 3, 20 rpm): 10-30 poise
   Density: 1.05±0.02 g/cm³
   Solids content: 58-62%
Properties noted above were provided by the supplier.

### Methods and Results

Compositions were made including: i) sand stabilized polypropylene (PP) fibers and cement; ii) sand stabilized with polyvinyl acetate fibers (PVAc) and cement: iii) sand stabilized with acrylic-based polymer emulsions; and iv) sand stabilized with polyvinyl acetate fibers (PVAc) and acrylic-based polymer emulsions. Compositions including sand and cement only were prepared as a comparison.

The sand used was fine grained formed mainly of quartz. The sand used was classified as SP and A-3 according to United Soil Classification System (USCS) and American Association of State Highway and Transportation Officials (AASHTO) classifications, respectively.

The sand samples without and with the stabilizers described above were tested to determine UCS according to ASTM D2166 and the mix exhibiting maximum UCS for each combination of sand and polypropylene/polyvinyl acetate fibers with 2% cement as well as sand with acrylic-based polymer emulsion were tested to determine the California bearing ratio according to ASTM D1883, direct shear according to ASTM D6528, permeability according to ASTM D2474 and durability according to ASTM D559.

To prepare the compositions, a first mix was performed with the sand and hydrocarbon derivative fibers (PP or PVAc fibers), then a second mix was performed with either cement and water or the acrylic-based polymer emulsion. The first mixing step was omitted for compositions that did not include the hydrocarbon derivative fibers.

Table 1 provides the unconfined compressive strength of sand with different stabilizers. The UCS value for sand with 7% cement by mass of sand was taken from Sung-Woo Mom et. al, Effect of fine particles on strength and stiffness of cement treated sand, Granular Matter (2020) 22:9 and the UCS value for sand with 0.2% PVAc and 0.5% polymer emulsion by mass of sand was calculated as described below.

The UCS of the composition with 2% cement was 369 kPa and the UCS of the composition with 2% cement and 0.2% PVAc fibers was 1411 kPa. Therefore, the increase in the UCS due to the presence of 0.2% PVAc fibers was calculated to be 1042 kPa based on the difference of the UCS of the two compositions. The UCS of the composition with 0.5% polymer emulsion was 1150 kPa. Taking a conservative value for the increase due to the presence of 0.2% PVAc fibers of 800 kPa, the UCS of a composition including 0.2% PVAc fibers and 0.5% polymer emulsion was estimated to be 1950 kPa.

TABLE 1
Unconfined compressive strength of sand with different stabilizers

| Composition | UCS (kPa) | Remarks |
|---|---|---|
| Sand only | 0 | |
| Sand with 2% by mass | 369 | |
| cement by mass of sand | | |
| Sand with 7% by mass | 1350 | Value taken from: Sung-Woo |
| cement by mass of sand | | Mom et. al, Effect of fine |
| | | particles on strength and |
| | | stiffness of cement treated |
| | | sand, Granular Matter (2020) |
| | | 22:9 |
| Sand with 2% cement | 776 | More than 100% increase in UCS |
| and 0.2% PP by mass | | compared to sand with 2% cement |
| of sand | | only |
| Sand with 2% cement | 741 | More than 100% increase in UCS |
| and 0.5% PP by mass | | compared to 2% cement only |
| of sand | | |
| Sand with 2% cement | 635 | More than 70% increase in UCS |
| and 1% PP by mass of | | compared to sand with 2% cement |
| sand | | only |
| Sand with 2% cement | 1411 | More than 280% increase in UCS |
| and 0.2% PVAc by mass | | compared to sand with 2% cement |
| of sand | | only |
| Sand with 2% cement | 1552 | More than 300% increase in UCS |
| and 0.5% PVAc by mass | | compared to sand with 2% cement |
| of sand | | only |
| Sand with 2% cement | 987 | More than 160% increase in UCS |
| and 1% PVAc by mass | | compared to sand with 2% cement |
| of sand | | only |
| 0.5% polymer emulsion | 1150 | More than 200% increase in UCS |
| by mass of sand | | compared to sand with 2% cement |
| | | only |
| 1% polymer emulsion by | 1245 | More than 230% increase in UCS |
| mass of sand | | compared to sand with 2% cement |
| | | only |
| 2% polymer emulsion by | 1050 | More than 180% increase in UCS |
| mass of sand | | compared to sand with 2% cement |
| | | only |
| 3% polymer emulsion by | 725 | More than 90% increase in UCS |
| mass of sand | | compared to sand with 2% cement |
| | | only |
| 4% polymer emulsion by | 600 | More than 60% increase in UCS |
| mass of sand | | compared to sand with 2% cement |
| | | only |
| 5% polymer emulsion by | 550 | More than 45% increase in UCS |
| mass of sand | | compared to sand with 2% cement |
| | | only |
| Sand with 0.2% PVAc | 1950 | Value was calculated; 428% |
| and 0.5% polymer | | increase in UCS compared to |
| emulsion by mass of | | sand with 2% cement only and |
| sand | | 45% increase in UCS compared |
| | | to sand with 7% cement only |

The improvement in the UCS due to the addition of 0.5% PVAc fibers and 2% cement was approximately 320% compared to the improvement using only 2% cement and approximately 15% compared to the improvement using only 7% cement. The improvement in the UCS due to the addition of 0.2% PVAc fibers and 2% cement was approximately 280% compared to the improvement using only 2% cement and approximately 5% compared to the improvement using only 7% cement. The improvement in the UCS due to the addition of 0.2% PP fibers and 2% cement was approximately 110% compared to the improvement using only 2% cement.

The improvement in the UCS due to the addition of 0.5% acrylic-based polymer emulsion was approximately 210% compared to the improvement using only 2% cement. The improvement in the UCS due to the addition of 1% acrylic-based polymer emulsion was approximately 235% compared to the improvement using only 2% cement.

The improvement in the UCS due to the addition of 0.2% PVAc fibers and 0.5% acrylic-based polymer emulsion was estimated to be approximately 428% compared to the improvement by using only 2% cement and approximately 45% compared to the improvement by using only 7% cement.

The mechanical and durability properties of sand stabilized with 2% cement and 0.5% PVAc (resulting in a UCS value if 1552 kPA, the highest amongst all above lab-tested combinations) are summarized in Table 2. These properties of sand stabilized with cement and PVAc fibers were superior to those stabilized with cement only.

TABLE 2
Mechanical and durability properties of sand stabilized
with 2% cement and 0.5% PVAc fibers.

| Property | Value | Remarks |
|---|---|---|
| Cohesion, kPa | 12 | Non-improved value of |
| | | sand was 0 kPa |
| California bearing ratio, % | 24 | Good/Base, subbase |
| Modulus of resilience, kPa | 2,550 | Good/Base, subbase |
| Coefficient of permeability, | 30.0 × 10⁻⁶ | Very low |
| cm/s | | |

Sand without additives has a cohesion value of 0 kPa whereas sand stabilized with 2% cement and 0.5% PVAc fibers had a cohesion value of 12 kPa. The measured values for the CBR resilience and permeability were all good.

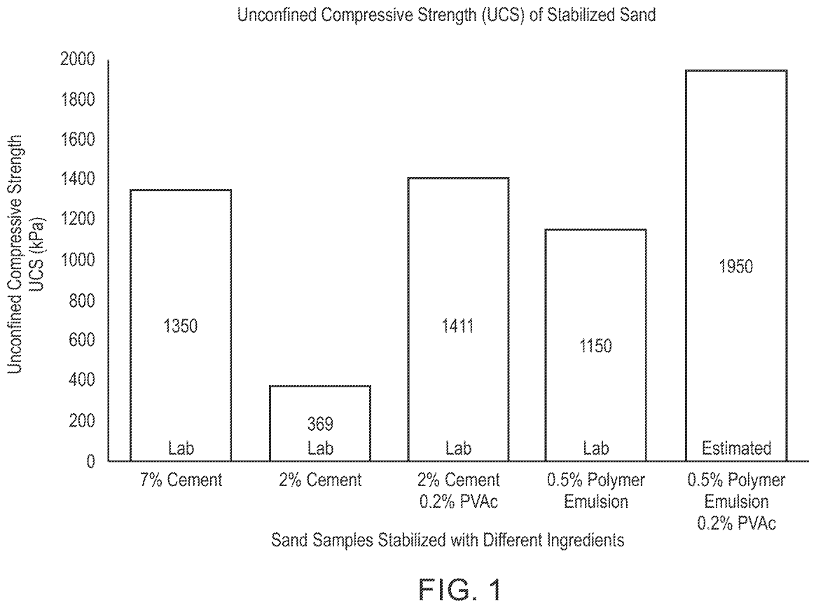

The UCS of selected compositions is shown in FIG. 1.

### Embodiments

1. A composition, including:
   sand;
   0.1% to 2% hydrocarbon derivative fibers by mass of the sand; and
   0.1% to 3% cement by mass of the sand.
2. The composition of embodiment 1, wherein the composition includes at least 95% by weight sand.
3. The composition of embodiment 1 or 2, wherein the composition includes:
   0.2% to 1% hydrocarbon derivative fibers by mass of the sand; and
   2% cement by mass of the sand.
4. The composition of any one of embodiments 1-3, wherein the hydrocarbon derivative fibers include a member selected from the group consisting of polypropylene fibers, polyethylene fibers, polyvinyl alcohol fibers, and polyvinyl acetate fibers.
5. The composition of any one of embodiments 1-4, wherein the composition includes:
   0.5% hydrocarbon derivative fibers by mass of the sand; and
   2% cement by mass of the sand, and
   the hydrocarbon derivative fibers include polyvinyl acetate fibers.
6. The composition of any one of embodiments 1-5, wherein the composition has an unconfined compressive strength of at least 600 kPa according to ASTM D2166.
7. The composition of embodiment 1 or 2, wherein the composition consists of:
   sand;
   0.1% to 2% hydrocarbon derivative fibers by mass of the sand; and
   0.1% to 3% cement by mass of the sand.
8. A system including:
   a structure including a member selected from the group consisting of a road bed, a foundation, an embankment, a highway, a dam, flexible pavement, rigid pavement, a water retaining structure, an erosion protection and mitigation structure, a pipe sleeper, a fence foundation, a small pump, a masonry wall foundation, and a slab on grade foundation; and
   the composition of any one of embodiments 1-7,
   wherein the composition supports at least a portion of the structure.
9. A composition, including:
   sand; and
   0.1% to 5% acrylic-based polymer emulsion by mass of the sand.
10. The composition of embodiment 9, wherein the composition includes at least 95% by weight sand.
11. The composition of embodiment 9 or 10, wherein the composition has an unconfined compressive strength of at least 500 kPa according to ASTM D2166.
12. The composition of any one of embodiment 9-11, wherein the composition consists of:
   sand; and
   0.1% to 5% acrylic-based polymer emulsion by mass of the sand.
13. A system including:
   a structure including a member selected from the group consisting of a road bed, a foundation, an embankment, a highway, a dam, flexible pavement, rigid pavement, a water retaining structure, an erosion protection and mitigation structure, a pipe sleeper, a fence foundation, a small pump, a masonry wall foundation, and a slab on grade foundation; and
   the composition of any one of embodiments 9-12,
   wherein the composition supports at least a portion of the structure.
14. A composition, including:
   sand;
   0.1% to 2% hydrocarbon derivative fibers by mass of the sand; and
   0.1% to 5% acrylic-based polymer emulsion by mass of the sand.
15. The composition of embodiment 14, wherein the composition includes at least 95% by weight sand.
16. The composition of embodiment 14 or 15, wherein the composition includes:
   0.2% hydrocarbon derivative fibers by mass of the sand; and
   0.5% cement by mass of the sand.
17. The composition of any one of embodiments 14-16, wherein the hydrocarbon derivative fibers include a member selected from the group consisting of polyvinyl acetate fibers, polypropylene fibers, polyethylene fibers, polyvinyl alcohol fibers, and polyvinyl acetate fibers.
18. The composition of any one of embodiments 14-17, wherein the composition has an unconfined compressive strength of at least 1900 kPa.
19. The composition of embodiment 14 or 15, wherein the composition consists of:
   sand;
   0.1% to 2% hydrocarbon derivative fibers by mass of the sand; and
   0.1% to 5% acrylic-based polymer emulsion by mass of the sand.
20. A system including:
   a structure including a member selected from the group consisting of a road bed, a foundation, an embankment, a highway, a dam, flexible pavement, rigid pavement, a water retaining structure, an erosion protection and mitigation structure, a pipe sleeper, a fence foundation, a small pump, a masonry wall foundation, and a slab on grade foundation; and
   the composition of any one of embodiments 14-19,
   wherein the composition supports at least a portion of the structure.

What is claimed:

1. A composition, comprising:
sand;
0.1% to 2% hydrocarbon derivative fibers by mass of the sand; and
0.1% to 3% cement by mass of the sand.

2. The composition of claim 1, wherein the composition comprises at least 95% by weight sand.

3. The composition of claim 1, wherein the composition comprises:
0.2% to 1% hydrocarbon derivative fibers by mass of the sand; and
2% cement by mass of the sand.

4. The composition of claim 1, wherein the hydrocarbon derivative fibers comprise a member selected from the group consisting of polypropylene fibers, polyethylene fibers, polyvinyl alcohol fibers, and polyvinyl acetate fibers.

5. The composition of claim 1, wherein the composition comprises:
0.5% hydrocarbon derivative fibers by mass of the sand; and
2% cement by mass of the sand, and
the hydrocarbon derivative fibers comprise polyvinyl acetate fibers.

6. The composition of claim 1, wherein the composition has an unconfined compressive strength of at least 600 kPa according to ASTM D2166.

7. The composition of claim 1, wherein the composition consists of:
sand;
0.1% to 2% hydrocarbon derivative fibers by mass of the sand; and
0.1% to 3% cement by mass of the sand.

8. A system comprising:
a structure comprising a member selected from the group consisting of a road bed, a foundation, an embankment, a highway, a dam, flexible pavement, rigid pavement, a water retaining structure, an erosion protection and mitigation structure, a pipe sleeper, a fence foundation, a small pump, a masonry wall foundation, and a slab on grade foundation; and
the composition of claim 1,
wherein the composition supports at least a portion of the structure.

9. A composition, comprising:
sand; and
0.1% to 5% acrylic-based polymer emulsion by mass of the sand.

10. The composition of claim 9, wherein the composition comprises at least 95% by weight sand.

11. The composition of claim 9, wherein the composition has an unconfined compressive strength of at least 500 kPa according to ASTM D2166.

12. The composition of claim 9, wherein the composition consists of:
sand; and
0.1% to 5% acrylic-based polymer emulsion by mass of the sand.

13. A system comprising:
a structure comprising a member selected from the group consisting of a road bed, a foundation, an embankment, a highway, a dam, flexible pavement, rigid pavement, a water retaining structure, an erosion protection and mitigation structure, a pipe sleeper, a fence foundation, a small pump, a masonry wall foundation, and a slab on grade foundation; and
the composition of claim 9,
wherein the composition supports at least a portion of the structure.

14. A composition, comprising:
sand;
0.1% to 2% hydrocarbon derivative fibers by mass of the sand; and
0.1% to 5% acrylic-based polymer emulsion by mass of the sand.

15. The composition of claim 14, wherein the composition comprises at least 95% by weight sand.

16. The composition of claim 14, wherein the composition comprises:
0.2% hydrocarbon derivative fibers by mass of the sand; and
0.5% cement by mass of the sand.

17. The composition of claim 14, wherein the hydrocarbon derivative fibers comprise a member selected from the group consisting of polyvinyl acetate fibers, polypropylene fibers, polyethylene fibers, polyvinyl alcohol fibers, and polyvinyl acetate fibers.

18. The composition of claim 14, wherein the composition has an unconfined compressive strength of at least 1900 kPa.

19. The composition of claim 14, wherein the composition consists of:
sand;
0.1% to 2% hydrocarbon derivative fibers by mass of the sand; and
0.1% to 5% acrylic-based polymer emulsion by mass of the sand.

20. A system comprising:
a structure comprising a member selected from the group consisting of a road bed, a foundation, an embankment, a highway, a dam, flexible pavement, rigid pavement, a water retaining structure, an erosion protection and mitigation structure, a pipe sleeper, a fence foundation, a small pump, a masonry wall foundation, and a slab on grade foundation; and
the composition of claim 14,
wherein the composition supports at least a portion of the structure.
